(19) United States
(12) Patent Application Publication
(10) Pub. No.: US 2005/0198219 A1
(43) Pub. Date: Sep. 8, 2005

(54) Unicast messaging for waking up sleeping devices

(75) Inventors: Dwip N. Banerjee, Austin, TX (US); Lilian Sylvia Fernandes, Austin (US); Vinit Jain, Austin, TX (US); Vasu Vallabhaneni, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/793,464

(22) Filed: Mar. 4, 2004

(51) Int. Cl. G06F 15/173; G06F 15/177

(52) U.S. Cl. 709/220; 709/223

(57) ABSTRACT

Returning to normal power mode a sleeping device operating in low power mode, where the sleeping device is connected to a network, and the sleeping device has a network layer address and a link layer address. Typical embodiments include configuring an administrative device connected to the network with the network layer address of the sleeping device, the link layer address of the sleeping device, and a network layer address of a last router on a route to the sleeping device; instructing the router to store the network layer address of the sleeping device in association with the link layer address of the sleeping device; sending from the administrative device to the sleeping device through the router a unicast message to return to normal power mode.

### BACKGROUND OF THE INVENTION

1. Field of the Invention

The field of the invention is data processing, or, more specifically, methods, systems, and products for returning a sleeping device to normal power mode.

2. Description of Related Art

Many devices that connect to networks for data communications are capable of operating in a low power mode in which the devices ignore all network communications except an instruction to return to normal power mode. One way of sending such a message to return to normal power mode is to send the message in a network packet that is communicated through a network router to a sleeping device on a LAN. The network packet uses as its destination address the network address of the sleeping device. The router may maintain a cache, referred to in this specification as an ‘ARP’ cache (for Address Resolution Protocol) that the router can use to resolve the network address into the LAN address (referred to as the ‘link layer address’) of the sleeping device. Entries in ARP tables, however, time out, so that there may be no useful entry in the ARP table. Moreover, although the network address might otherwise be resolved by use of an ARP query broadcast to all devices on the LAN, in this kind of case, the destination device is asleep, so that it ignores all messages except a wake up message—including the ARP query. So there is a definite risk that a message addressed specifically to the sleeping device, a so-called ‘unicast’ message, will not get through.

One way this problem is addressed is to use a subnet-directed broadcast message, instead of a unicast, to transmit the message to all devices on a LAN. The subnet-directed broadcast is implemented in an Internet Protocol setting, for example, by setting the host portion of the network address to all ones and the network portion of the address to the network address of a router on the LAN. In this way, the wake up message is sent to all the devices on the LAN, including the sleeping device. The message is encoded with the LAN address or link layer address of the sleeping device and is therefore ignored by all other devices on the LAN—except the sleeping device, which wakes up, returns to normal power mode, when it detects the wake up message. This is an inefficient procedure, however, because all devices on the LAN must process the wake up message, even though it is intended for only one of the devices.

### SUMMARY OF THE INVENTION

Methods, systems, and products are disclosed for returning to normal power mode a sleeping device operating in low power mode by use of a unicast message instead of a broadcast or multicast, thereby eliminating the need for all devices on a subnet to process a wake up message intended for only one of them. More particularly, methods, systems, and products are disclosed for returning to normal power mode a sleeping device operating in low power mode, where the sleeping device is connected to a network, and the sleeping device has a network layer address and a link layer address. Typical embodiments include configuring an administrative device connected to the network with the network layer address of the sleeping device, the link layer address of the sleeping device, and a network layer address of a last router on a route to the sleeping device; instructing the router to store the network layer address of the sleeping device in association with the link layer address of the sleeping device; sending from the administrative device to the sleeping device through the router a unicast message to return to normal power mode.

In many embodiments, instructing the router to store the network layer address of the sleeping device in association with the link layer address of the sleeping device further comprises transmitting, from the administrative device to the router, a message bearing the network layer address of the sleeping device and the link layer address of the sleeping device. Such embodiments typically also include storing in the router in response to the message the network layer address of the sleeping device in association with the link layer address of the sleeping device. In many embodiments, the message bearing the network layer address of the sleeping device and the link layer address of the sleeping device is a DHCP offer message.

In typical embodiments, transmitting, from the administrative device to the router, a message bearing the network layer address of the sleeping device and the link layer address of the sleeping device also includes creating in the administrative device a DHCP offer message and transmitting the DHCP offer message to a DHCP relay agent on the router. In many embodiments, the message comprises a DHCP offer message, and storing the network layer address of the sleeping device in association with the link layer address of the sleeping device includes storing through a DHCP relay agent on the router an ARP cache entry including the network layer address of the sleeping device and the link layer address of the sleeping device.

In typical embodiments, sending from the administrative device to the sleeping device a unicast message to return to normal power mode includes receiving the unicast message in the router as a network layer message addressed to the network layer address of the sleeping device, retrieving the stored link layer address of the sleeping device, and transmitting the unicast message as a link layer message to the sleeping device. In such embodiments, the unicast message to return to normal power mode includes a message type code identifying the message as an instruction to return to normal power mode.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 depicts an architecture for a data processing system in which various embodiments of the present invention may be implemented.

FIG. 2 sets forth a block diagram of an exemplary protocol stack for data communications between two devices connected through a network.

FIG. 3 sets forth a block diagram of automated computing machinery comprising a computer useful in various forms of administrative device or sleeping device in systems for returning a sleeping device to normal power mode according to embodiments of the present invention.

FIG. 4 sets forth a flow chart illustrating an exemplary method for returning to normal power mode a sleeping device operating in low power mode.

FIG. 5 sets forth a flow chart illustrating an exemplary method of data processing in a router for returning a sleeping device to normal power mode.

FIG. 6 sets forth a flow chart illustrating an exemplary method of processing in a data communications adapter in a sleeping device a unicast message to return to normal power mode.

### DETAILED DESCRIPTION OF EXEMPLARY EMBODIMENTS

### Introduction

The present invention is described to a large extent in this specification in terms of methods for returning a sleeping device to normal power mode. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Returning a Sleeping Device to Normal Power Mode

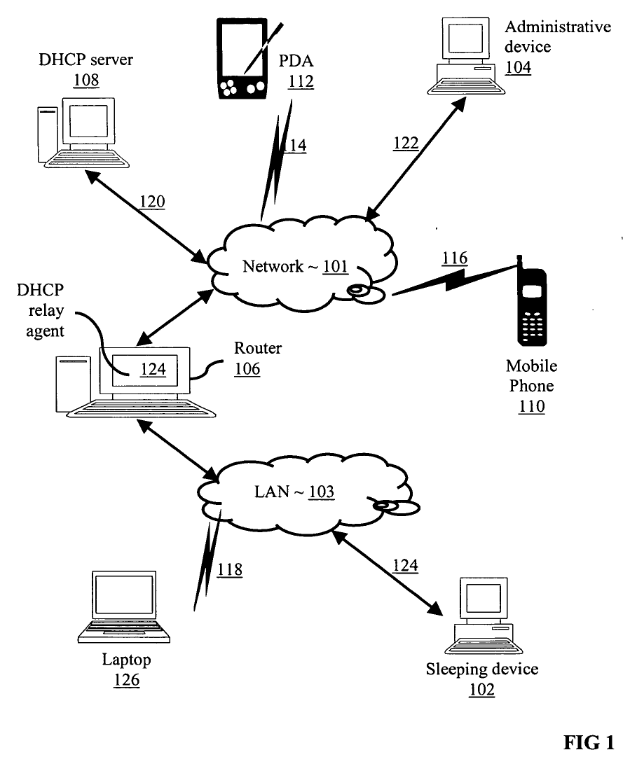

Exemplary methods, systems, and products for returning a sleeping device to normal power mode are now explained with reference to the accompanying drawings, beginning with FIG. 1. FIG. 1 depicts an architecture for a data processing system in which various embodiments of the present invention may be implemented. The data processing system of FIG. 1 includes a number of computers connected for data communications in networks. The data processing system of FIG. 1 includes network (101) and local area network (“LAN”) (103). Network (101) and LAN (103) are connected through router (106), forming a wide area network or “WAN.” The network connection aspect of the architecture of FIG. 1 is only for explanation, not for limitation. In fact, systems for returning a sleeping device to normal power mode according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, several exemplary devices including a PDA (112), an administrative device (104), a mobile phone (110), and a DHCP server (108) are connected to network (101). Network-enabled mobile phone (110) connects to network (101) through wireless link (116), and PDA (112) connects to network (101) through wireless link (114). In the example of FIG. 1, DHCP server (108) connects through wireline connection (120) to network (101), and administrative device (104) connects through wireline connection (122) to network (101). Laptop (126) connects through wireless link (118) to LAN (103), and sleeping device (102) connects through wireline connection (124) to LAN (103).

In the example of FIG. 1, administrative device (104) is depicted as a personal computer or desktop computer workstation, a depiction that is for explanation, not for limitation. In fact, any automated computing machinery capable of data communications may implement an administrative device according to embodiments of the present invention. Examples of devices that may be programmed to operate as an administrative device according to the present invention include laptops, wireless handheld devices, personal digital assistants (“PDAs”), network-enabled mobile phones, and so on, as will occur to those of skill in the art.

In the example of FIG. 1, sleeping device (102) is depicted as a personal computer or desktop computer workstation, a depiction that is for explanation, not for limitation. In fact, any automated computing machinery capable of data communications that can operate in low power mode as well as normal power mode may implement a sleeping device according to embodiments of the present invention. Examples of devices that may be implemented to operate as a sleeping device according to the present invention include laptops, wireless handheld devices, personal digital assistants (“PDAs”), network-enabled mobile phones, and so on, as will occur to those of skill in the art.

The arrangement of servers and other devices making up the architecture illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, such as, for example, TCP/IP, HTTP, WAP, HDTP, and others as will occur to those of skill in the art. Various embodiments of the present invention may be implemented on a variety of hardware platforms in addition to those illustrated in FIG. 1.

The exemplary system of FIG. 1 may be operated generally for returning to normal power mode a sleeping device (102) operating in low power mode by configuring an administrative device (104) connected to the network with the network layer address of the sleeping device, the link layer address of the sleeping device, and a network layer address of a last router (106) on a route to the sleeping device. Administrative device (104) may be configured by storing in computer memory on the administrative device the network address of the sleeping device, the link layer address of the sleeping device, and a network address for last router on a network data communication route to the sleeping device. The last router on a route to the sleeping device in a router operating a data communication port to the LAN that links the sleeping device to the wider network. In the example, of FIG. 1, only one router (106) is illustrated, but readers of skill in the art will recognize that most routes through wide area networks, such as, for example, the Internet, include connections through several routers. The last router may be identified, for example, by use of operating system utility programs such as ‘tracert’ in Microsoft NT and ‘traceroute’ in Linux and other Unix variants.

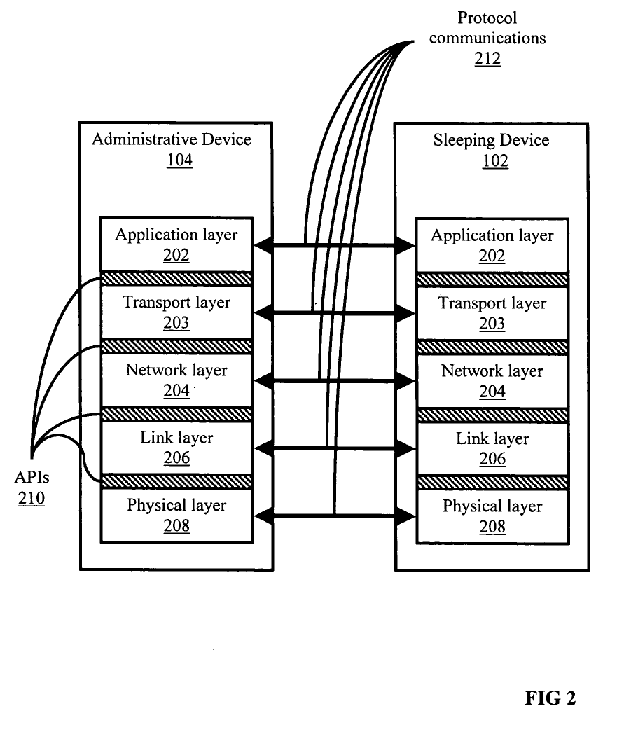

The network addresses and the link layer address of the sleeping device are explained with reference to FIG. 2. FIG. 2 sets forth a block diagram of an exemplary protocol stack for data communications between two devices connected through a network. The exemplary protocol stack of FIG. 2 is based loosely on the standard Open Systems Interconnection (“OSI”) Reference Model, presented here only for use in explaining an exemplary embodiment. The exemplary protocol stack of FIG. 2 includes several protocols stacked in layers. The exemplary protocol stack of FIG. 2 begins at the bottom with a physical layer (208) that delivers unstructured streams of bits across links between devices. Physical layer connections may be implemented as wireline connections through modems or wireless connections through wireless communications adapters, for example. The exemplary stack of FIG. 2 includes a link layer (206) that delivers a piece of information across a single link. The link layer organizes the physical layer's bits into packets and controls which device on a shared link gets each packet. The Ethernet protocol represents a link layer protocol. Ethernet addresses are 48 bit link layer addresses assigned uniquely to linked devices. A group of devices linked through a link layer protocol are often referred to as a LAN. An IEEE committee in one popular standard split the link layer in two sublayers, the first of which, called the MAC layer (for ‘media access control’) addresses issues specific to a particular type of LAN—so that a link layer address is often referred to as a ‘MAC addresses.’ The present specification, however, is not limited to any particular kind of LAN and therefore refers to link layer addresses as ‘link layer addresses.’

Because each link layer address is unique to a device on a LAN, link layer protocol (206) operates generally by circulating all messages packets on a LAN to each device connected to the LAN. Each packet includes a destination link layer address. Each device is then responsible for examining each packet, and discarding those not addressed to the device, and passing those that are addressed to the device up the protocol stack for further handling.

The stack of FIG. 2 includes a network layer (204) that computes paths across an interconnected mesh of links and packet switches and forwards packets over multiple links from source to destination. In this specification, packet switches operating in the network layer are referred to as “routers.” The stack of FIG. 2 includes a transport layer (203) that supports a reliable communication stream between a pair of devices across a network by putting sequence numbers in packets, holding packets at the destination until all arrive, and retransmitting lost packets. The stack of FIG. 2 also includes an application layer where application programs reside that use the network. Examples of such application programs include web browsers, email clients, and administrative application programs according to embodiments of the present invention.

Data communications (212) in such a stack model is viewed as occurring layer by layer between devices, in this example, between an administrative device (104), upon which is installed an administrative application program according to an embodiment of the present invention, and a sleeping device (102) connected to the administrative device through a network but operating in low power mode. That is, data communication between the devices in the physical layer is viewed as occurring only in the physical layer, communication in the link layer is viewed as occurring horizontally between the devices only in the link layer, and so on.

Vertical communication through among the protocols in the stack is viewed as occurring through application programming interfaces (“APIs”) (210) provided for that purpose. A browser, for example, operating as an application program in the application layer views its communications as coming and going directly to and from its counterpart web server on another device across the network. The browser effects its data communication by calls to a sockets API that in turn operates a transmission control protocol (“TCP”) client in the transport layer. The TCP client breaks a message into packets, gives each packet a transport layer header that includes a sequence number, and sends each packet to its counterpart on another device through an API call to the network layer. The network layer may implement, for example, the well known Internet Protocol (“IP”) which give each packet an IP header and selects a communication route through the network for each packet, and transmits each packet to its counterpart on another device by calling down through its link layer API, typically implemented as a driver API for a data communication card such as a network interface card or “NIC.” When receiving data communication, the process is reversed. Each layer strips off its header and passes a received packet up through the protocol stack. Upward passes above the link layer typically required operating system context switches.

Again referring to the example of FIG. 1, router (106), upon receiving at its network address a packet having a network address of a device on the LAN served by the router, must resolve the network address into a link layer address for the device. One way to resolve a network address is with an ARP query. An address resolution protocol (“ARP”) query is a message broadcast to all the devices on the LAN for which the router seeks a corresponding link layer address. That is, all devices on the LAN are sent a link layer packet asking for their link layer addresses. The packet includes the sought network layer address. All devices on the LAN discard the ARP query except for the device whose network address matches the network address in the query; that device sends its link layer address to the router. To save time in link layer address resolution, a router typically stores recently resolved network addresses in association with their corresponding link layer addresses in an ‘ARP cache.’ An example of an ARP cache is shown in Table 1:

TABLE 1
Exemplary ARP Cache

| Network Layer Address | Link Layer Address | Type |
|---|---|---|
| 199.199.40.1 | 00 00 0c 1a eb c5 | Dynamic |
| 199.199.40.124 | 00 dd 01 07 57 15 | Dynamic |
| 10.57.10.32 | 00 60 8c 0e 6c 6a | Static |

Routers may serve more than only port on more than one LAN, but for ease of explanation, Table 1 illustrates an ARP cache for a single LAN on a single port on a single router. Table 1 associates network layer addresses and link layer addresses in two entry types, dynamic and static. Static ARP cache entries are hand-entered and remain in the cache. Dynamic entries store ‘learned addresses’ entered automatically by the router in response to ARP queries or DHCP offer messages, for example, and dynamic entries are ‘aged’ for an ‘aging time.’ That is, dynamic ARP cache entries time out according to the cache's aging time and are then deleted from the ARP cache. Typical aging times range from a few seconds to a few minutes or more.

In the example of FIG. 1, router (106) includes a DHCP relay agent (124) that supports communications between devices joining the network and one or more DHCP servers (108). The Dynamic Host Configuration Protocol (“DHCP”) is a protocol for assigning dynamic network addresses to devices on a network. Dynamic addressing simplifies network administration by automatically tracking network addresses rather than requiring an administrator to manage the task. This means that a new computer can be added to a network without the overhead of manually assigning it a unique network address.

DHCP includes DHCP ‘discover’ messages that devices broadcast to locate available DHCP servers. In return, available DHCP servers send DHCP ‘offer’ messages to a device with an offer of configuration parameters. A device then broadcasts a DHCP ‘request’ message requesting offered parameters from a server and implicitly declining offers from all others. The selected DHCP server then transmits a DHCP ‘package’ message to the new device on the network with configuration parameters, including a committed network address.

In cases where a device connecting to a network does not reside on the same LAN with a DHCP server, some kind of relay agent is needed to transfer DHCP requests to between new devices and DHCP servers. A DHCP relay agent is a BOOTP relay agent as described in IETF RFC-1541. A DHCP relay agent, when relaying a discover message from a device to a server, inserts its own network address in the message, so that offer messages sent in return are not routed around the network but instead are sent directly from a responding DHCP server to the relay agent for the device. Each relay agent is installed on a router. DHCP request messages are packaged as network packets. In an IP network, DHCP messages travel in IP packets each addressed to port 68 or port 67, depending on whether the message is to or from a server or a client. Any network packet addressed to port 67 arriving in a router that supports DHCP is handed to the relay agent for processing. All offer messages returning from DHCP servers to devices connecting to the network include the device's link layer address. In typical processing, a relay agent receiving a DHCP offer message uses the device's network layer address and link layer address from the offer message to create an ARP cache entry storing those addresses in association with one another.

In the architecture of FIG. 1, administrative device (104) operates generally to return sleeping device (102) to normal power mode by sending to the sleeping device through the router (106) a unicast message to return to normal power mode. When the unicast message arrives in the router addressed to the sleeping device at the sleeping device's network address, the router cannot resolve the sleeping device's network address to a link layer address with an ARP query because the sleeping device operating in low power mode is discarding all link layer packets except for a packet bearing a link layer unicast message instructing the sleeping device to return to normal power mode. In typical implementation of administrative device (104) according to embodiments of the present invention therefore, the administrative devices advantageously instructs the router (106) to store the network layer address of the sleeping device (102) in association with the link layer address of the sleeping device. One way to instruct a router to store a network layer address of a sleeping device in association with a link layer address of the sleeping device is to send the router a DHCP offer message so that the router, in response to the message, makes a dynamic ARP entry in its ARP cache storing the network layer address and the associated link layer address.

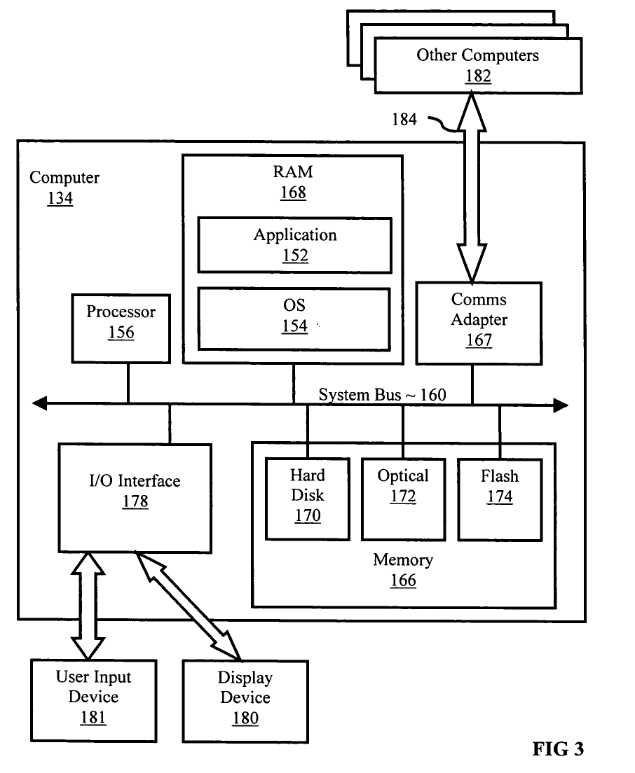

As mentioned above, administrative devices and sleeping devices according to embodiments of the present invention are generally implemented as automated computing machinery. For further explanation, FIG. 3 sets forth a block diagram of automated computing machinery comprising a computer (134) useful in various forms of administrative device or sleeping device in systems for returning a sleeping device to normal power mode according to embodiments of the present invention. The computer (134) of FIG. 3 includes at least one computer processor (156) or ‘CPU’ as well as random access memory (168) (“RAM”). Stored in RAM (168) is an application program (152). Application programs include in particular computer software instructions for returning sleeping devices to normal power mode in accordance with embodiments of the present invention. Also stored in RAM (168) is an operating system (154). Operating systems useful in computers according to embodiments of the present invention include Unix, Linux, Microsoft NT™, and many others as will occur to those of skill in the art.

The computer (134) of FIG. 3 includes computer memory (166) coupled through a system bus (160) to processor (156) and to other components of the computer. Computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer (134) of FIG. 3 includes a communications adapter (167) for implementing connections for data communications (184), including connection through networks, to other computers (182), servers, clients, administrative devices, or sleeping devices. Communications adapters implement the hardware level of connections for data communications through which local devices and remote devices or servers send data communications directly to one another and through networks. Communications adapters according to embodiments of the present invention operate generally in low power mode by discarding all messages not addressed to the sleeping device on which the communication adapter is installed and also discarding all messages addressed to the sleeping device that are not a unicast message to return to normal power mode. Examples of communications adapters that may be tailored to operate according to embodiments of the present invention include modems for wired dial-up connections, Ethernet (IEEE 802.3) adapters for wired LAN connections, and 802.11b adapters for wireless LAN connections.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

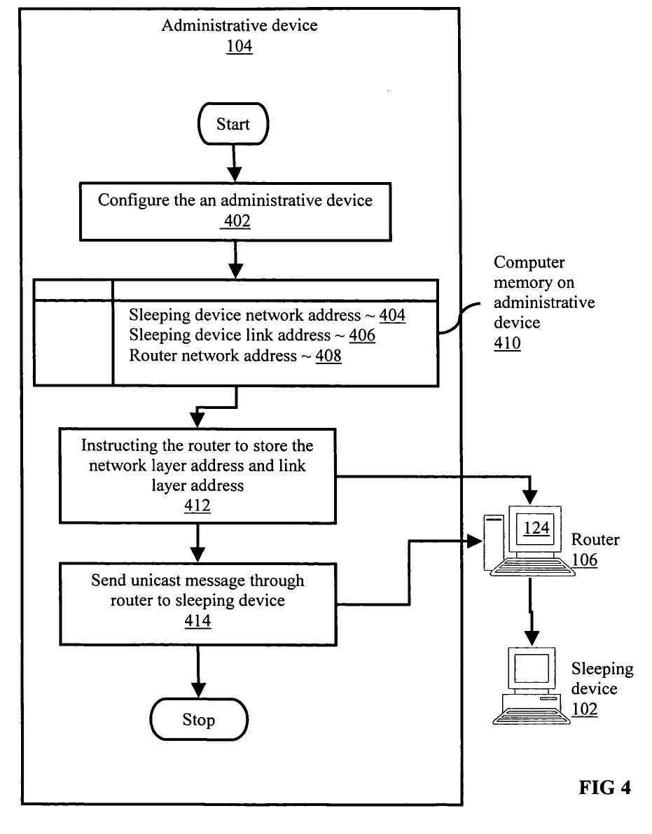

By way of further explanation, FIG. 4 sets forth a flow chart illustrating an exemplary method for returning to normal power mode a sleeping device (102) operating in low power mode. In the example of FIG. 4, the sleeping device is connected to a network through a LAN (as illustrated in FIG. 1), and the sleeping device has a network layer address and a link layer address. The method of FIG. 4 includes configuring (402) an administrative device (104) connected to the network with the network layer address (404) of the sleeping device, the link layer address (406) of the sleeping device, and a network layer address (408) of a last router (106) on a route to the sleeping device. In the method of FIG. 4, configuring the administrative device may include identifying the last router as the last router listed on a ‘tracert’ or ‘traceroute’ listing for a route from an administrative device to a sleeping device. Configuring the administrative device may include entering the network layer address (404) of the sleeping device, the link layer address (406) of the sleeping device, and the network layer address (408) of the last router (106) on a route to the sleeping device through a data entry screen, the data entry screen operating as a graphical user interface, for example, for an administrative application program that stores the network layer address (404) of the sleeping device, the link layer address (406) of the sleeping device, and the network layer address (408) of the last router (106) on a route to the sleeping device in computer memory on the administrative device.

The method of FIG. 4 also includes instructing (412) the router (106) to store the network layer address (404) of the sleeping device (102) in association with the link layer address (406) of the sleeping device. In the method of FIG. 4, instructing (412) the router (106) to store the network layer address (404) of the sleeping device in association with the link layer address (406) of the sleeping device may be carried out by transmitting, from the administrative device to the router, a message bearing the network layer address of the sleeping device and the link layer address of the sleeping device. In the method of FIG. 4, transmitting, from the administrative device to the router, a message bearing the network layer address of the sleeping device and the link layer address of the sleeping device may be carried out by creating in the administrative device a DHCP offer message and transmitting the DHCP offer message to a DHCP relay agent on the router.

The method of FIG. 4 also includes sending (414) from the administrative device (104) to the sleeping device (102) through the router (106) a unicast message to return to normal power mode. A unicast message is a message addressed to a single device, in this case, the sleeping device. The unicast message may be transmitted, for example, using the Transport Control Protocol or “TCP” in the transport layer and IP in the network layer. The unicast message may also be sent, for another example, using the User Datagram Protocol or “UDP” in the transport layer and IP in the network layer. In fact, the unicast message may be transmitted using any workable combination of protocols as will occur to those of skill in the art.

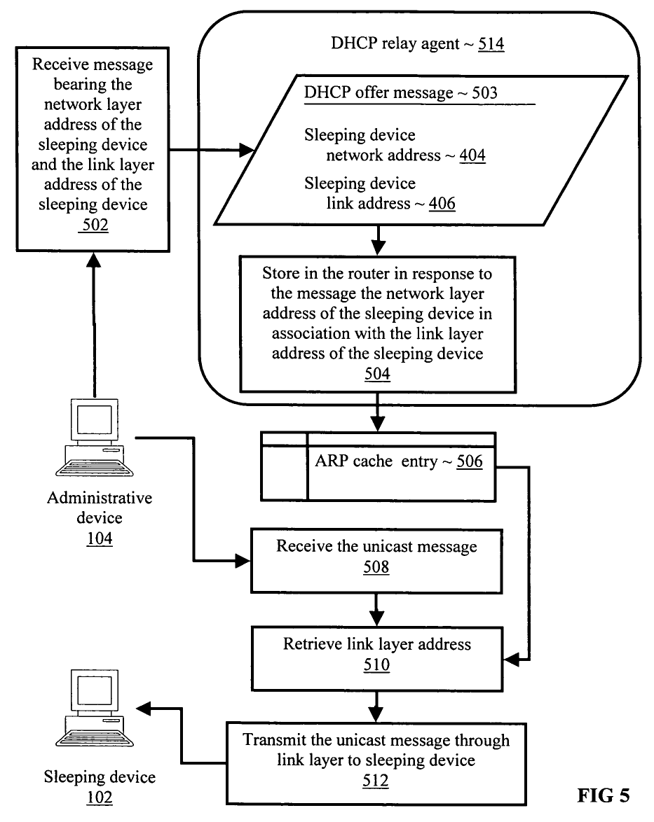

By way of further explanation, FIG. 5 sets forth a flow chart illustrating an exemplary method of data processing in a router for returning a sleeping device to normal power mode. The method of FIG. 5 includes receiving (502) in the router the message bearing the network layer address of the sleeping device and the link layer address of the sleeping device. The method of FIG. 5 also includes storing (504) in the router in response to the message the network layer address of the sleeping device in association with the link layer address of the sleeping device. In the method of FIG. 5, the message (503) bearing the network layer address of the sleeping device and the link layer address of the sleeping device may be a DHCP offer message. In the method of FIG. 5, storing (504) the network layer address of the sleeping device in association with the link layer address of the sleeping device may be carried out by storing through a DHCP relay agent (124) on the router an ARP cache entry (506) including the network layer address (404) of the sleeping device and the link layer address (406) of the sleeping device.

FIG. 5 also illustrates router support for the process of sending from the administrative device to the sleeping device a unicast message to return to normal power mode. That is, the method of FIG. 5 includes receiving (508) the unicast message in the router as a network layer message addressed to the network layer address of the sleeping device. In the method of FIG. 5, the router resolves the link layer address in dependence upon the network layer address of the sleeping device by retrieving (510) the stored link layer address of the sleeping device. In the example of FIG. 5, the router retrieves the stored link layer address by retrieving from an ARP cache an ARP entry (506) bearing the network layer address of the sleeping device; that ARP entry also carries the link layer address of the sleeping device. The method of FIG. 5 then proceeds by transmitting (512) the unicast message as a link layer message to the sleeping device.

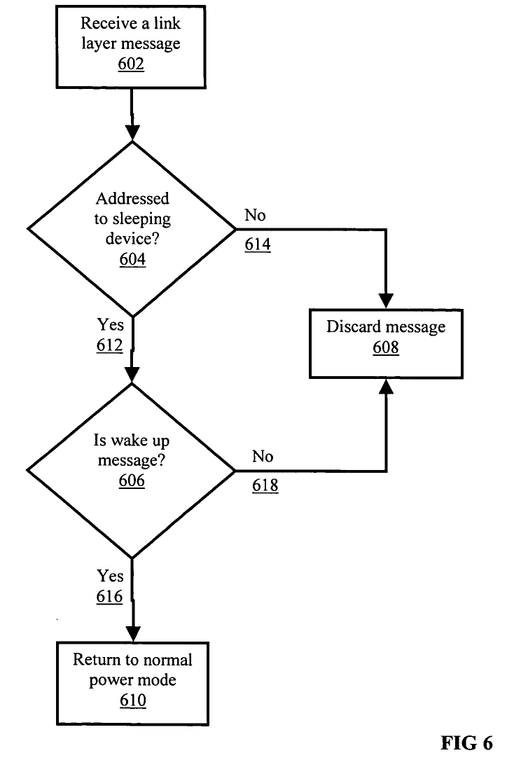

For further explanation, FIG. 6 sets forth a flow chart illustrating an exemplary method of processing in a data communications adapter in a sleeping device a unicast message to return to normal power mode. Receiving (602) a link layer message in the example of FIG. 6 is carried out by receiving all messages transmitted through the link layer in a LAN to which a sleeping device is connected. The sleeping device's data communications adapter is powered normally although most of the remaining hardware on the sleeping device is powered down. The sleeping device discard (608) all messages not addressed (614) to the sleeping device. In addition, among messages addressed to the sleeping device, the sleeping device discards (608) all messages that are not a unicast message to return to normal power mode.

In the method of FIG. 6, a unicast message to return to normal power mode advantageously includes a message type code identifying the message as an instruction to return to normal power mode. The unicast message in the link layer also must meet the basic requirements for the LAN technology chosen, including, for example, formatting source address and destination address according to the specifications of the underlying LAN. In an Ethernet LAN, for example, a message type code identifying the message as an instruction to return to normal power mode may be implemented as a sequence of 16 duplications of the link layer address of the sleeping device. Such a sequence may be located anywhere within the packet and is advantageously preceded by a synchronization stream. The synchronization stream allows an Ethernet adapter to be simpler than it would need to be to interpret other kinds of message type codes. The synchronization stream may be defined, for example, as 6 bytes of FF. If the link layer address for the sleeping device is 00 dd 01 07 57 15, then the Ethernet controller would scanning for the following data sequence:

DESTINATION SOURCE MISC FF FF FF FF FF FF 00 dd
01 07 57 15 00 dd 01 07 57 15 00 dd 01 07 57 15 00 dd 01 07
57 15 00 dd 01 07 57 15 00 dd 01 07 57 15 00 dd 01 07 57 15
00 dd 01 07 57 15 00 dd 01 07 57 15 00 dd 01 07 57 15 00 dd
01 07 57 15 00 dd 01 07 57 15 00 dd 01 07 57 15 00 dd 01 07
57 15 00 dd 01 07 57 15 00 dd 01 07 57 15 MISC CRC

Such an Ethernet card's circuitry may be tailored slightly by addition of a counter to identify the message type code by counting the 16 duplications of the link layer address, with another circuit to reset the counter for packets that do not contain the message type code. It takes little design effort to tailor a communications adapter in this way, which is an advantage of a solution that uses the link layer address as the message type code identifying a message as an instruction to return to normal power mode, because the circuitry to detect the link layer address already exists on the communications adapter. This is an example of one way to implement a message type code identifying a message as an instruction to return to normal power mode—by using the link layer address of a sleeping device to form the message type code. This example is for explanation only, however, not for limitation. In fact, any message type code as may occur to those of skill in the art is well within the scope of the present invention, including, for example, the text: “Wake Up Now Please.”

An advantage of the class of embodiments that use DHCP offer messages or their equivalent to refresh a cache mapping network addresses to link addresses is that they may be implemented with no need to modify any routers. Similarly, network adapters, such as Ethernet NIC cards, for example, may be tailored to operate according to embodiments of the present invention with no need to modify network operating systems. More particularly, if the computer hardware of a sleeping device or its Basic Input/Output System (“BIOS”) is responsible for returning the sleeping device to normal power mode, then the operating system on the sleeping device may not need to be changed at all—because the operating system may have no need to know whether the sleeping device has been awake or asleep.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for returning to normal power mode a sleeping device operating in low power mode, wherein the sleeping device is connected to a network and the sleeping device has a network layer address and a link layer address, the method comprising:
configuring an administrative device connected to the network with the network layer address of the sleeping device, the link layer address of the sleeping device, and a network layer address of a last router on a route to the sleeping device;
instructing the router to store the network layer address of the sleeping device in association with the link layer address of the sleeping device;
sending from the administrative device to the sleeping device through the router a unicast message to return to normal power mode.

2. The method of claim 1 wherein:
instructing the router to store the network layer address of the sleeping device in association with the link layer address of the sleeping device further comprises transmitting, from the administrative device to the router, a message bearing the network layer address of the sleeping device and the link layer address of the sleeping device; and
the method further comprises storing in the router in response to the message the network layer address of the sleeping device in association with the link layer address of the sleeping device.

3. The method of claim 2 wherein the message bearing the network layer address of the sleeping device and the link layer address of the sleeping device is a DHCP offer message.

4. The method of claim 2 wherein transmitting, from the administrative device to the router, a message bearing the network layer address of the sleeping device and the link layer address of the sleeping device further comprises:
creating in the administrative device a DHCP offer message; and
transmitting the DHCP offer message to a DHCP relay agent on the router.

5. The method of claim 2 wherein:
the message comprises a DHCP offer message; and
storing the network layer address of the sleeping device in association with the link layer address of the sleeping device further comprises storing through a DHCP relay agent on the router an ARP cache entry including the network layer address of the sleeping device and the link layer address of the sleeping device.

6. The method of claim 1 wherein sending from the administrative device to the sleeping device a unicast message to return to normal power mode further comprises:
receiving the unicast message in the router as a network layer message addressed to the network layer address of the sleeping device;
retrieving the stored link layer address of the sleeping device; and
transmitting the unicast message as a link layer message to the sleeping device.

7. The method of claim 1 wherein the unicast message to return to normal power mode includes a message type code identifying the message as an instruction to return to normal power mode.

8. A system for returning to normal power mode a sleeping device operating in low power mode, wherein the sleeping device is connected to a network and the sleeping device has a network layer address and a link layer address, the system comprising:
means for configuring an administrative device connected to the network with the network layer address of the sleeping device, the link layer address of the sleeping device, and a network layer address of a last router on a route to the sleeping device;
means for instructing the router to store the network layer address of the sleeping device in association with the link layer address of the sleeping device;
means for sending from the administrative device to the sleeping device through the router a unicast message to return to normal power mode.

9. The system of claim 8 wherein:
means for instructing the router to store the network layer address of the sleeping device in association with the link layer address of the sleeping device further comprises means for transmitting, from the administrative device to the router, a message bearing the network layer address of the sleeping device and the link layer address of the sleeping device; and
the system further comprises means for storing in the router in response to the message the network layer address of the sleeping device in association with the link layer address of the sleeping device.

10. The system of claim 9 wherein the message bearing the network layer address of the sleeping device and the link layer address of the sleeping device is a DHCP offer message.

11. The system of claim 9 wherein means for transmitting, from the administrative device to the router, a message bearing the network layer address of the sleeping device and the link layer address of the sleeping device further comprises:
means for creating in the administrative device a DHCP offer message; and
means for transmitting the DHCP offer message to a DHCP relay agent on the router.

12. The system of claim 9 wherein:
the message comprises a DHCP offer message; and
means for storing the network layer address of the sleeping device in association with the link layer address of the sleeping device further comprises means for storing through a DHCP relay agent on the router an ARP cache entry including the network layer address of the sleeping device and the link layer address of the sleeping device.

13. The system of claim 8 wherein means for sending from the administrative device to the sleeping device a unicast message to return to normal power mode further comprises:
means for receiving the unicast message in the router as a network layer message addressed to the network layer address of the sleeping device;
means for retrieving the stored link layer address of the sleeping device; and
means for transmitting the unicast message as a link layer message to the sleeping device.

14. The system of claim 8 wherein the unicast message to return to normal power mode includes a message type code identifying the message as an instruction to return to normal power mode.

15. A computer program product for returning to normal power mode a sleeping device operating in low power mode, wherein the sleeping device is connected to a network and the sleeping device has a network layer address and a link layer address, the computer program product comprising:
a recording medium;
means, recorded on the recording medium, for configuring an administrative device connected to the network with the network layer address of the sleeping device, the link layer address of the sleeping device, and a network layer address of a last router on a route to the sleeping device;
means, recorded on the recording medium, for instructing the router to store the network layer address of the sleeping device in association with the link layer address of the sleeping device;
means, recorded on the recording medium, for sending from the administrative device to the sleeping device through the router a unicast message to return to normal power mode.

16. The computer program product of claim 15 wherein:
means, recorded on the recording medium, for instructing the router to store the network layer address of the sleeping device in association with the link layer address of the sleeping device further comprises means, recorded on the recording medium, for transmitting, from the administrative device to the router, a message bearing the network layer address of the sleeping device and the link layer address of the sleeping device; and
the computer program product further comprises means, recorded on the recording medium, for storing in the router in response to the message the network layer address of the sleeping device in association with the link layer address of the sleeping device.

17. The computer program product of claim 16 wherein the message bearing the network layer address of the sleeping device and the link layer address of the sleeping device is a DHCP offer message.

18. The computer program product of claim 16 wherein means, recorded on the recording medium, for transmitting, from the administrative device to the router, a message bearing the network layer address of the sleeping device and the link layer address of the sleeping device further comprises:
means, recorded on the recording medium, for creating in the administrative device a DHCP offer message; and
means, recorded on the recording medium, for transmitting the DHCP offer message to a DHCP relay agent on the router.

19. The computer program product of claim 16 wherein:
the message comprises a DHCP offer message; and
means, recorded on the recording medium, for storing the network layer address of the sleeping device in association with the link layer address of the sleeping device further comprises means, recorded on the recording medium, for storing through a DHCP relay agent on the router an ARP cache entry including the network layer address of the sleeping device and the link layer address of the sleeping device.

20. The computer program product of claim 15 wherein means, recorded on the recording medium, for sending from the administrative device to the sleeping device a unicast message to return to normal power mode further comprises:
means, recorded on the recording medium, for receiving the unicast message in the router as a network layer message addressed to the network layer address of the sleeping device;
means, recorded on the recording medium, for retrieving the stored link layer address of the sleeping device; and
means, recorded on the recording medium, for transmitting the unicast message as a link layer message to the sleeping device.

21. The computer program product of claim 15 wherein the unicast message to return to normal power mode includes a message type code identifying the message as an instruction to return to normal power mode.
